(19) United States
(12) Patent Application Publication
(10) Pub. No.: US 2026/0073077 A1
(43) Pub. Date: Mar. 12, 2026

(54) TEXT REDACTION SYSTEM FOR PROTECTING PERSONAL IDENTIFYING INFORMATION

(71) Applicant: eBay Inc., San Jose, CA (US)

(72) Inventors: Hee Jin Lee, Austin, TX (US); Zhen Guo, Atlanta, GA (US); Morteza Moazami Goudarzi, Cambridge, MA (US)

(21) Appl. No.: 18/883,267

(22) Filed: Sep. 12, 2024

(51) Int. Cl. G06F 21/62; G06F 40/123; G06F 40/166; G06F 40/295

(52) U.S. Cl. CPC G06F 21/6254; G06F 40/123; G06F 40/166; G06F 40/295

(57) ABSTRACT

Systems and methods are directed to redacting and reinstating personal identifying information (PII) from text data. A PII management system accesses an input text and identifies, using one or more redaction components, PII mentions in the input text to be redacted. A placeholder manager of the PII management system replaces each unique PII string of a final set of PII mentions with a non-PII string to generate redacted text, whereby the non-PII string is generated by the placeholder manager. The placeholder manager also generates a mapping dictionary that maps each unique PII string to the non-PII string that replaces it. The mapping dictionary is used to reinsert one or more unique PII strings after processing of the redacted text. The redacted text is then transmitted to a downstream component for the processing.

### TECHNICAL FIELD

The subject matter disclosed herein generally relates to protecting personal identifying information (PII). Specifically, the present disclosure addresses systems and methods that automates text redaction of PII from text data while maintaining a mapping dictionary that allows for reinsertion of the PII after processing of the redacted text.

### BACKGROUND

Identifying and removing personal identifying information (PII) from free text data is a critical task in complying with laws and maintaining customer trust. This is especially true in the era of large language model (LLM) usage. In situations where the text data needs to be processed by downstream systems that can be operated by third parties, it is even more critical that PII obtained and maintained by a business entity is protected and not inadvertently passed on.

### BRIEF DESCRIPTION OF THE DRAWINGS

FIG. 1 is a diagram illustrating an example network environment suitable for redacting personal identifying information (PII) from text data for downstream processing, according to example implementations.

FIG. 2 is a diagram illustrating components of a PII management system, according to example implementations.

FIG. 3A-FIG. 3E illustrate an example of PII redaction and placeholder dictionary generation, according to example implementations.

FIG. 4 is a flowchart illustrating a method for performing automated PII redaction and generation of the placeholder dictionary, according to example implementations.

FIG. 5 is a flowchart illustrating a method for reinserting PII information after downstream processing, according to example implementations.

FIG. 6 is a block diagram illustrating components of a machine, according to some examples, able to read instructions from a machine-storage medium and perform any one or more of the methodologies discussed herein.

### DETAILED DESCRIPTION

The description that follows describes systems, methods, techniques, instruction sequences, and computing machine program products that illustrate examples of the present subject matter. In the following description, for purposes of explanation, numerous specific details are set forth in order to provide an understanding of various examples of the present subject matter. It will be evident, however, to those skilled in the art, that examples of the present subject matter may be practiced without some or other of these specific details. Examples merely typify possible variations. Unless explicitly stated otherwise, structures (e.g., structural components) are optional and may be combined or subdivided, and operations (e.g., in a procedure, algorithm, or other function) may vary in sequence or be combined or subdivided.

Systems and methods that redact personal identifying information (PII) from text data in an automated manner is discussed herein. To comply with laws and maintain customer trust, it is vital to handle PII or other sensitive data carefully. In the era of large language models (LLMs), the imperative to identify and prevent misuse of such data becomes increasingly important. In various use cases, there may be over 250 data elements categorized as confidential or restricted data. These data elements should be redacted from the text data before any downstream processing. This is especially true when the downstream processing is performed by an external processing system, such as an external LLM.

In particular, example implementations provide a PII management system that redacts PII mentions from text data, replaces each redacted PII mention (also referred to herein as a “unique PII string”) with a placeholder (e.g., also referred to herein as a “non-PII string”). In some implementations, the PII management system initially over-redacts the text data by liberally identifying all text strings that can possibly contain PII to minimize the risk of leaking any PII information. For example, all text strings with numbers may initially be identified as a PII mention candidate. The PII management system then unredacts text spans that are not PII mentions by identifying and removing spuriously identified PII mentions. For instance, a number that represents a quantity, temperature, or percentage is not likely PII. The merging of the over-redacted text strings and the unredact text spans results in a final set of PII mentions.

In example implementations, a placeholder manager of the PII management system generates a non-PII string (e.g., a hash code, a non-PII version of the PII mention/string) for each PII mention or unique PII string in the final set. Each unique PII string is then replaced by a corresponding non-PII string in the text data to generate redacted text. The placeholder manager also maintains a mapping dictionary that maps each unique PII string to the non-PII string that replaces it. By generating a mapping dictionary, one or more of the unique PII strings can be reinserted after processing of the redacted text by a downstream system.

As a result, example implementations provide a technical solution to the technical problem of securing customer data, especially when the customer data is processed by downstream systems that may be under the control of a third-party. In particular, the technical solution can over-redact text data and then unredact text spans that are not PII mentions in an automated manner. The over-redaction and unredaction can, in some implementations, be performed by machine-trained redactors and unredactors. Each unique PII string in a resultant set of PII mentions are then replaced in the text data by a system-generated placeholder or non-PII string and a corresponding mapping dictionary generated and maintained by the PII management system. The redacted text can then be transmitted for downstream processing while maintaining customer data security.

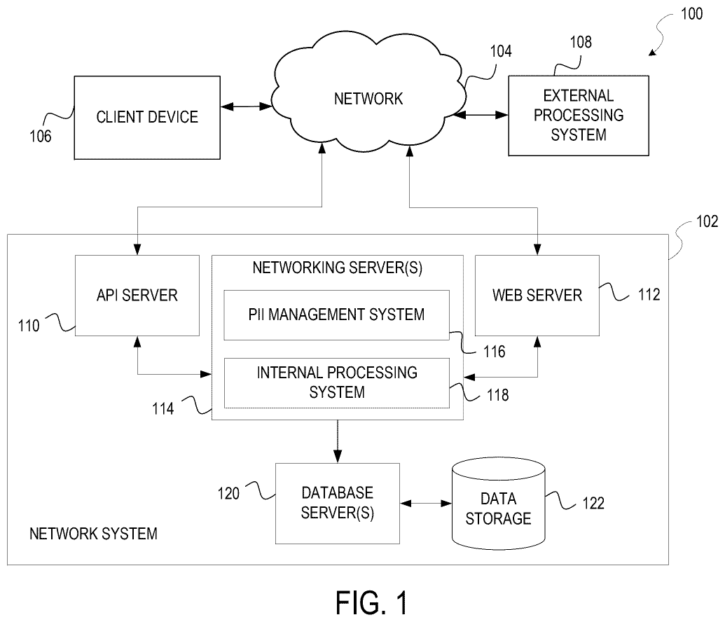

FIG. 1 is a diagram illustrating an example network environment 100 suitable for redacting personal identifying information (PII) from text data for further processing, according to example implementations. In example implementations, the text data includes free text data. A network system 102 provides server-side functionality via a communication network 104 (e.g., the Internet, wireless network, cellular network, or a Wide Area Network (WAN)) to a client device 106. The network system 102 is configured to manage securing PII in text data that may be further processed by downstream systems, as will be discussed in more detail below.

In various cases, the client device 106 is a device associated with a user of the network system 102, such as a customer of an entity that operates the network system 102. For example, the client device 106 can be a device associated with a user that uses the network system 102 to conduct a transaction and/or request customer service (e.g., via a form, chat session, email communications). The client device 106 may comprise, but is not limited to, a smartphone, a tablet, a laptop, multi-processor systems, microprocessor-based or programmable consumer electronics, a desktop computer, a server, or any other communication device that can access the network system 102. The client device 106 can include an application that exchanges data, via the network 104, with the network system 102. For example, the application can be browser application or a local version of an application associated with the network system 102 that can provide data to and access data from one or more components at the network system 102.

In example implementations, the client device 106 interfaces with the network system 102 via a connection with the network 104. Depending on the form of the client device 106, any of a variety of types of connections and networks 104 may be used. For example, the connection may be Code Division Multiple Access (CDMA) connection, a Global System for Mobile communications (GSM) connection, or another type of cellular connection. Such a connection may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, or other data transfer technology (e.g., fourth generation wireless, 4G networks, 5G networks). When such technology is employed, the network 104 includes a cellular network that has a plurality of cell sites of overlapping geographic coverage, interconnected by cellular telephone exchanges. These cellular telephone exchanges are coupled to a network backbone (e.g., the public switched telephone network (PSTN), a packet-switched data network, or other types of networks.

In another example, the connection to the network 104 is a Wireless Fidelity (e.g., Wi-Fi, IEEE 802.11x type) connection, a Worldwide Interoperability for Microwave Access (WiMAX) connection, or another type of wireless data connection. In such an example, the network 104 includes one or more wireless access points coupled to a local area network (LAN), a wide area network (WAN), the Internet, or another packet-switched data network. In yet another example, the connection to the network 104 is a wired connection (e.g., an Ethernet link) and the network 104 is a LAN, a WAN, the Internet, or another packet-switched data network. Accordingly, a variety of different configurations are expressly contemplated.

The external processing system 108 is a third-party system that performs data operations or processing for the network system 102. For example, the external processing system can comprise an LLM or generative artificial intelligence (AI) that processes data on behalf of the network system 102. The LLM is a trained model configured to generate text and perform natural language processing tasks. Generally, the LLM 108 learns relationships from a large data set during a training process and can then be used to generate text by taking an input and repeatedly predicting a next token or word, for example. For instance, the LLM 108 can generate a probability for the next tokens and select a proper one (e.g., highest probability) for output. While the LLM can be embodiments within the external processing system 108, the LLM 108 can, in some implementations, be a part of the network system 102 (e.g., be located within and under the control of the network system 102).

Turning specifically to the network system 102, an application programing interface (API) server 110 and a web server 112 are coupled to and provide programmatic and web interfaces respectively to one or more networking servers 114. The networking servers 114 host various systems including a PII management system 116 and an internal processing system 118, each comprising a plurality of components and each of which can be embodied as a combination of hardware, software, and/or firmware. The networking servers 114 can comprise other system based on the nature of the network system 102. For example, if the network system 102 is associated with a commerce entity, the networking servers can comprise a transaction system and a customer service/chat system.

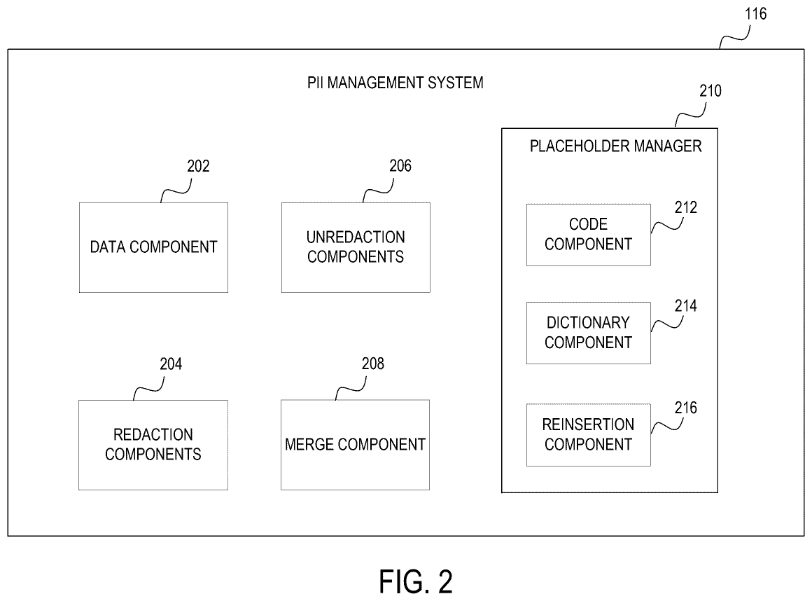

The PII management system 116 is configured to secure PII of users/customers of the network system 102. In example implementations, the PII management system 116 redacts PII mentions from text data (also referred to herein as “input text”) prior to the text data being processed by a downstream system. The downstream system can comprise the external processing system 108 of a third-party or the internal processing system 118. The PII management system 116 will be discussed in more detail in connection with FIG. 2-FIG. 5 below.

The internal processing system 118 can be any system or service of the network system 102 that uses the text data to perform some operation. For example, the internal processing system 118 can be an internal LLM that summarizes the redacted text data. As another example, the internal processing system 118 can train one or more machine learning models for internal or external use using both the redacted text data and the original text data. For example, the internal processing system 118 can train components of the PII management system 116. The machine learning involves training on past text data that have been redacted by the PII management system 116. Accordingly, text data prior to redaction and corresponding redacted text data is access and various attributes extracted. The attributes (also referred to as “features”) can include redacted terms (e.g., PII mentions/strings) and corresponding metadata such as a corresponding category of the redacted terms. One or more redactors (e.g., redactor models) can then be trained with training data comprising the extracted features to identify PII strings and/or non-PII strings (e.g., probability that a text span is a PII string and/or not a PII string). These redactors can be continuously updated (e.g., on a daily or weekly basis) based on new training data (e.g., new text data redactions). The machine learning can occur using linear regression, logistic regression, a decision tree, an artificial neural network, k-nearest neighbors, and/or k-means, to name a few examples.

The networking servers 114 can be, in turn, coupled to one or more database servers 120 that facilitate access to one or more storage repositories or data storage 122. The data storage 122 is a storage device storing, for example, user accounts including user profiles of users of the network system 102 and records of transactions or communications between the user and the network system 102 or other users of the network system 102.

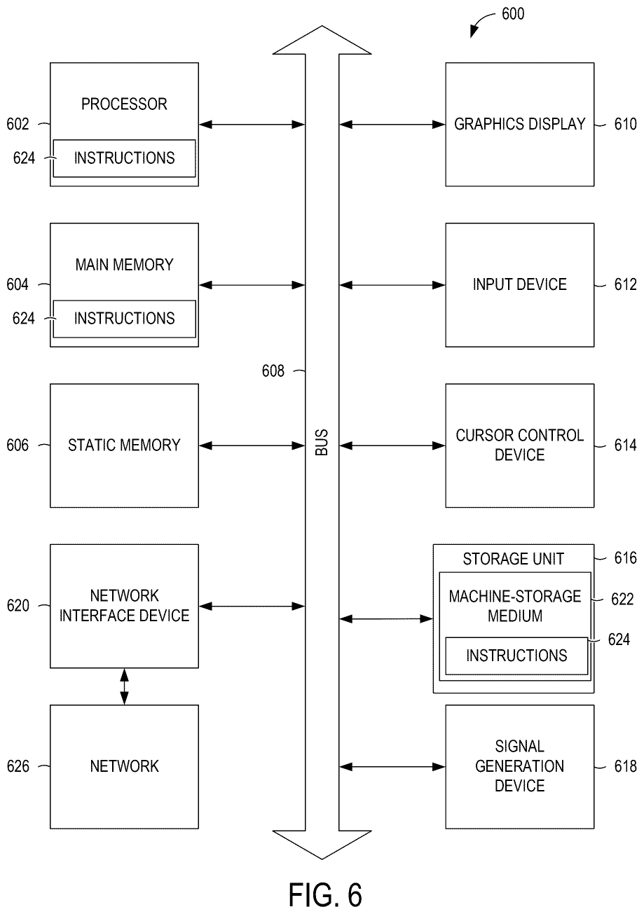

Any of the systems, data storage, servers, or devices (collectively referred to as “components”) shown in, or associated with, FIG. 1 may be, include, or otherwise be implemented in a special-purpose (e.g., specialized or otherwise non-generic) computer that can be modified (e.g., configured or programmed by software, such as one or more software components of an application, operating system, firmware, middleware, or other program) to perform one or more of the functions described herein for that system or machine. For example, a special-purpose computer system able to implement any one or more of the methodologies described herein is discussed below with respect to FIG. 6, and such a special-purpose computer is a means for performing any one or more of the methodologies discussed herein. Within the technical field of such special-purpose computers, a special-purpose computer that has been modified by the structures discussed herein to perform the functions discussed herein is technically improved compared to other special-purpose computers that lack the structures discussed herein or are otherwise unable to perform the functions discussed herein. Accordingly, a special-purpose machine configured according to the systems and methods discussed herein provides an improvement to the technology of similar special-purpose machines.

Moreover, any two or more of the components illustrated in FIG. 1 may be combined, and the functions described herein for any single component may be subdivided among multiple components. Functionalities of one component may, in alternative examples, be embodied in a different component. Additionally, any number of client devices 106 and data storage 120 may be embodied within the network environment 100. While only a single network system 102 is shown, alternatively, more than one network system 102 can be included (e.g., localized to a particular region).

FIG. 2 is a diagram illustrating components of the PII management system 116, according to example implementations. In example implementations, the PII management system 116 comprises a server that manages PII security and redacts PII mentions from text data prior to downstream processing. The PII management system 116 also generates a mapping dictionary that maps each redacted PII string to each non-PII string that replaces it in the redacted text. To enable these operations, the PII management system 116 comprises a data component 202, redaction components 204, unredaction components 206, a merge component 208, and a placeholder manager 210 configured in communication with one another (e.g., via a bus, shared memory, or a switch).

The data component 202 accesses text data (also referred to as “input text”) that needs to be redacted prior to processing. The data component 202 can receive the input text directly from the client device 106 and/or from another component of the network system 102 (e.g., other systems within the network servers 114). For example, the input text can be a chat conversation between a user at the client device 106 and an agent associated with the network system 102 in substantially real-time. Alternatively, the input text can be stored data (e.g., accessed from the data storage 122). Other examples of input text can include, for example, web forms, transaction/order records, email communications, transcriptions of verbal conversations, SMS message transacripts, and so forth.

The redaction components 204 are configured to redact the input text. In some case, the redaction components 204 are designed to over-redact the input text. In example implementations, the redaction components 204 comprises two redactors—a regular expression (regex) redactor and a named-entity recognition (NER) redactor. Alternative implementations can comprise any number and/or types of redactors.

The regex redactor and NER redactor are configured to identify different types of data elements that should be restricted out. Specifically, the regex redactor targets categories including email addresses, IBAN codes, phone numbers, number sequences, and alphanumeric sequences. As such, the regex redactor has one or more regex patterns (or rules) for each target PII category. These patterns are matched against an entire input text for, for example, email address (EMAIL_ADDRESS), bank account number (IBAN_CODE), and phone number (PHONE_NUMBER), while matched per token basis for number sequences (NUM_SEQ) and alphanumeric sequences (ALPHANUM_SEQ).

The NER redactor uses algorithms that function based on grammar, statistical natural language processing (NLP) models, and/or predictive models. The algorithms are trained on datasets that have been labeled with predefined named entity categories, such as people, locations, organizations, percentages, and monetary values. As such, the NER redactor targets categories including currency/money information, date information, location information, person information (e.g., name), organization information, and keywords. Thus, the NER redactor uses a trained model (e.g., “ner-english-ontonotes-large” model from the flair package) to predict data elements in its PII categories. In some cases, to reduce spurious predictions, when an ORG category entity is predicted with, for example, the name of the entity associated with the network system 102, the prediction can be ignored.

In some implementations, rules for the Regex redactor and the NER redactor, itself, can be machine-trained to identify PII in their respective categories. The training can be performed, for example, by the internal processing system 118 as discussed above. In an alternative implementation, a component of the PII management system 116 performs the machine-training of the redaction components 204.

The outputs of the redaction components 204 are merged by the merge component 208. Specifically, text spans (e.g., PII mentions) that are identified by the regex redactor and the NER redactor are aggregated by the merge component 208 into a set of PII candidates. While example implementations discuss the redaction components 204 comprising a regex redactor and a NER redactor, the redaction components 204 can, instead, comprise only a regex redactor, only a NER redactor, other types of redactors, or any combinations of these.

The unredaction components 206 are configured to identify non-PII mentions in the same input text. Similar to the redaction components 204, the unredaction components 206 can comprise a regex unredactor and a NER unredactor having similar respective PII categories and rules. For example, since the regex redactor redacts any appearance of numbers in the input text, the unredactor components 206 aim to find non-PII numbers in the input text. Accordingly, the regex unredactor contains patterns of expressions that are not PII. These regex patterns can, for example, target descriptions of time (e.g., “02:00 AM”), percentages (e.g., “90.0%”), ordinal numbers (e.g., “12th”), time durations (e.g., “2-3 business days”), and quantity of things (e.g., “3 negative reviews”). For example, some number of minutes is not PII (e.g., 2-3 minutes).

In some implementations, the NER unredactor uses the same machine-trained model as the NER redactor, but with different types of entities. For example, the model can identify “DATE” and “TIME” where a “DATE” type entity is a candidate for redaction while a “TIME” type entity is a candidate for unredaction. Thus, the NER unredactor uses predictions of type/category as spans for unredaction. For instance, if NER finds date information such as “today,” this is most likely not PII in, for example, a chat transcript setting. As such, the NER unredactor will indicate that this is not a PII string/mention. In another example, an entity name associated with a shipping company (e.g., UPS, FedEx) in a transaction can be identified as not a PII mention since it is not PII associated with a user.

In some implementations, both rules for the regex unredactor and the NER unredactor, itself, can be machine-trained to identify non-PII in their respective categories. The training can be performed, for example, by the internal processing system 118 as discussed above. In an alternative implementation, a component of the PII management system 116 performs the machine-training for the unredaction components 206. For example, rules for the regex unredactor can be trained such that certain instances of time, percentages, ordinal numbers, quantities, and time durations are identified as not PII. Similarly, the NER unredactor can be trained such that certain instances of entity names and particular date information are identified as not PII.

While example implementations discuss the unredaction components 206 comprising a regex unredactor and a NER unredactor, the unredaction components 206 can, instead, comprise only a regex unredactor, only a NER unredactor, other types of unredactors, or any combinations of these.

The text spans identified by the unredaction components 206 that are not PII mentions in the input text (also referred to as an “unredaction PII candidate”) are then transmitted to the merge component 208. The merge component 208 essentially functions as a summation node that removes any PII mentions identified by the redaction components 204 that correspond to a non-PII mention. The correspondence can be direct (e.g., the PII mention matches the non-PII mention), the PII mention somehow overlaps with the non-PII mention, or a text span identified as a PII mention is entirely contained within a text span that is not a PII mention. The result is a final set of PII mentions that should be redacted from the input text.

In some implementations, the merge component 208 is rules-based. For instance, if any PII mention candidate overlaps with any unredaction PII candidate, the unredaction PII candidate will win. However, PII can be more complicated. For example, as discussed above, “today” is an unredaction PII candidate. However, an example text can be “[Agent]: Could you please share your DOB? [Customer]: Oh it's actually today, 1995.” Here, “today” will be identified as a redaction candidate by redaction components 204, and as a unredaction PII candidate by the unredaction components 206. If a simple rule that unredaction always wins is applied, then the PII management system 116 may wrongly miss this PII (e.g., date of birth). Thus, a machine-trained merge component 208 can make a better decision utilizing the meaning of the whole text.

As such, alternative implementations can machine-train the merge component 208. Here the machine training would involve extraction of features that indicate when a PII candidate is kept even though it corresponds to an unredaction PII candidate and when a PII candidate is removed when it corresponds to an unredaction PII candidate. These features are then used to train a merge model. The merge model can be periodically updated with new training data as additional merges are performed by the PII management system 116.

While example implementations provide redaction components 204 that are configured to over-redact the input text, alternative implementations can use or train redaction components 204 that precisely redact the input text. These redaction components 204 can be trained, for example, with training data that that identifies both PII mentions and non-PII mentions. In these alternative implementations, the unredaction components 206 may not be necessary.

The placeholder manager 210 is configured to redact the input text using the final set of PII mentions. Example implementations also maintain a record of what is redacted so that the redacted PII mentions can be reinserted after downstream processing. As such, the placeholder manager 210 comprises a code component 212, a dictionary component 214, and a reinsertion component 216 coupled in communication.

The code component 212 is configured to generate a non-PII (text) string for each corresponding PII mention in the final set of PII mentions (also referred to herein as a “unique PII string”) and replace each corresponding PII mention with its non-PII string. In some implementations, the non-PII string is a unique hashcode comprising a category and a random sequence of text. Including the category in the non-PII string provides context for the input text without providing the original value/string. The categories are identified by the various redactors (e.g., the redaction components 204 and/or the unredaction components 206) and passed to the placeholder manager 210 as metadata. For example, if the unique PII string is “Joshua,” then the code component 212 can generate a unique random hashcode “Person_345672B8.” In another example, if the unique PII string is “New York,” then the code component 212 can generate a unique random hashcode “Location_ M349Y847.” In some implementations, the non-PII string is a non-original PII string of the same category. For example, the randomly generated non-PII string for “Joshua” can be “Steven,” while the randomly-generated non-PII string for “New York” can be “Houston.” Further still, any random non-PII string can be used regardless of the category. If the unique PII string occurs more than once in the input text, then every instance of the same unique PII string will be replaced with the same non-PII string. By randomly generating the non-PII string, any downstream system cannot simply make an intelligent guess (e.g., based on past input text) what the corresponding unique PII string is.

The dictionary component 214 is configured to generate a mapping dictionary that is a record of the mappings of each unique PII string to the non-PII string that replaces it. The mapping dictionary can be used to reinsert one or more of the unique PII strings after processing of the redacted text by a downstream system. The mapping dictionary can be stored for at least a duration of the downstream processing in a cache or database (e.g., data storage 122).

The reinsertion component 216 is configured to reinsert one or more of the unique PII strings back into the result of the processed redacted text. In some implementations, the PII management system 116 receives the result of the downstream processing which still contains at least some of the non-PII strings. For example, if the downstream processing is a generative artificial intelligence (AI) system, in the prompt engineering side, a few short examples can be provided or the generative AI system can be explicitly told in the prompt to keep particular patterns (e.g., the non-PII strings) in the output.

The reinsertion component 216 accesses the mapping dictionary that is associated with the processed redacted text. The reinsertion component 216 uses the mapping to identify the one or more unique PII strings that correspond to the one or more non-PII strings in the processed result. In implementations where the reinsertion component 216 receives the result of the processed redacted text, the one or more PII strings are reinserted, by the reinsertion component 216, into the result by replacing the corresponding non-PII strings with the PII strings.

In some implementations, the mapping dictionary is transmitted to a further system (e.g., the internal processing system 118) that performs the reinsertion. The further system can be a system within the network system 102. For example, the external processing system 108 processes the redacted text and provides the result to the further system of the network system 102 that is outside of the PII management system 116. This further system can reinsert the unique PII strings into the result using the mapping dictionary provided by the placeholder manager 210.

In an alternative implementation, the mapping dictionary is maintained by the dictionary component 214 and the further system sends a request for the matching unique PII strings to the reinsertion component 216. The request can comprise a list of the non-PII strings. The reinsertion component 216 performs a lookup for the matching PII strings and generates a response that provides the mapping information.

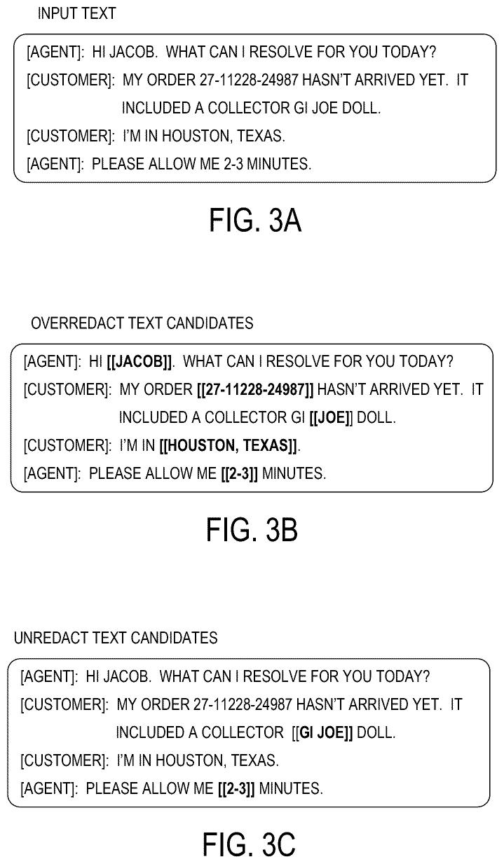

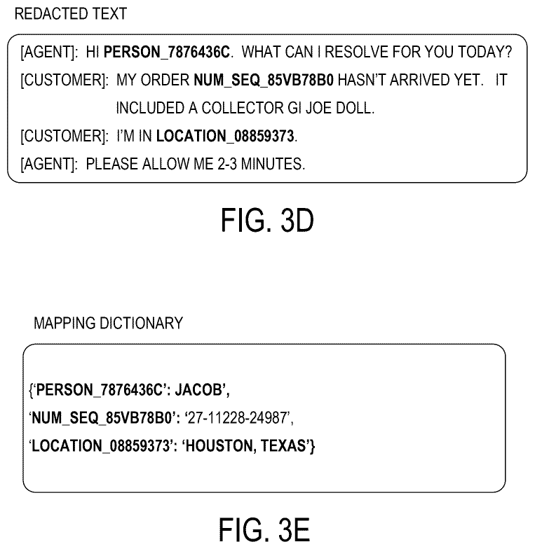

FIG. 3A-FIG. 3E illustrate an example of PII redaction and placeholder dictionary generation, according to example implementations. The input text of the example of FIG. 3A-FIG. 3E comprises a customer service transcript that involves a conversation between a customer service agent and a customer. The communication can be verbal or via a chat session. FIG. 3A shows a portion of the conversation which comprises the input text.

The redaction components 204 initially over-redacts the input text by identifying every possible instance of a PII mention. Referring to FIG. 3B, a regex redactor of the redaction components 204 identifies an alphanumeric sequence “27-11228-24987” that is an order number and a number sequence “2-3.” A NER redactor of the redaction components 204 identifies a first person that is a customer's name “Jacob,” a second person “Joe,” and the customer's location “Houston, Texas.” These identified PII mention candidates are shown within brackets in FIG. 3B.

The unredaction components 206 identify non-PII mentions in the same input text. Referring now to FIG. 3C, a regex unredactor of the unredaction components 206 identifies that the number sequence “2-3” is not a PII mention. Similarly, a NER unredactor of the unredaction components 206 identifies the person “GI Joe” is not PII mention. These identified text spans that are not PII mentions are show in brackets in FIG. 3C.

The PII mention candidates from the redaction components 204 and the unredact text spans from the unredaction component 206 are merged by the merge component 208. The merge component 208 removes any PII mentions identified by the redaction components 204 that correspond to a non-PII mention. The correspondence can be direct (e.g., the PII mention “2-3” matches the non-PII mention “2-3”) or a text span identified as a candidate PII mention is entirely contained within a text span that is not a PII mention (e.g., the PII mention “Joe” is contained within the non-PII mention “GI Joe”). The result is a final set of PII mentions that should be redacted from the input text.

The final set of PII mentions are transmitted to the placeholder manager 210, which generates a code or non-PII string for each PII mention/string in the final set and redacts the input text using the non-PII strings. Referring now to FIG. 3D, “Jacob” is replaced with a non-PII string (e.g., hashcode) “Person_7876436C;” “27-11228-24987” is replaced with a non-PII string “Num_Seq_85VB78B0;” and “Houston, Texas” is replaced with a non-PII string “Location_08859373” to derive the redacted text. The redacted text can now be transmitted to a downstream system for further processing.

The placeholder manager 210 also generates a mapping dictionary that maps the above redactions. FIG. 3E shows an example mapping dictionary that is generated. The mapping dictionary can be stored for use by the reinsertion component 216 and/or transmitted to a further system which will use the mapping dictionary to reinsert the unique PII strings after downstream processing.

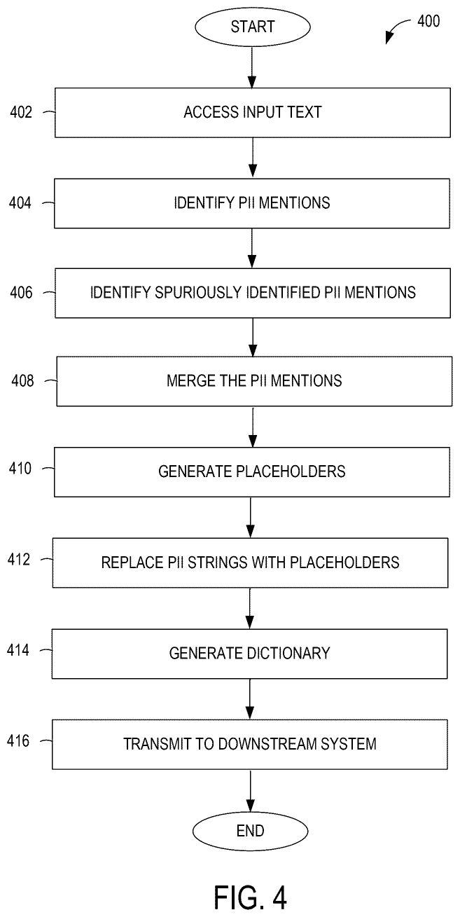

FIG. 4 is a flowchart illustrating a method 400 for performing automated PII redaction and generation of the placeholder dictionary, according to example implementations. Operations in the method 400 may be performed by the PII management system 116, using components described above in part with respect to FIG. 2. Accordingly, the method 400 is described by way of example with reference to the PII management system 116. However, it shall be appreciated that at least some of the operations of the method 400 may be deployed on various other hardware configurations or be performed by similar components residing elsewhere in the network environment 100. Therefore, the method 400 is not intended to be limited to the PII management system 116.

In operation 402, the data component 202 accesses input text that needs redaction prior to processing. The data component 202 can receive the input text directly from the client device 106 and/or from another component of the network system 102. The data component 202 can also access the input text from a database (e.g., data storage 122).

In operation 404, the redaction components 204 identify PII mentions in the input text that are candidates for redaction. In example implementations, the redaction components 204 comprise a regex redactor and a NER redactor. The regex redactor looks for (e.g., pattern matches) PII mentions that indicate, for example, email addresses, IBAN codes, phone numbers, number sequences, and alphanumeric sequences. The NER redactor identifies PII mentions that include currency/money information, date information, location information, person information (e.g., name), organization information, and keywords based on a trained model. The outputs (e.g., text spans of PII mentions) of the redaction components 204 are merged by the merge component 208 into a set of PII mention candidates.

In some implementations, the redaction components 204 overredacts the input text (e.g., liberally identifies every possible PII mention). In these implementations, the unredaction components 206 identifies spuriously identified PII mentions that should not be redacted in operation 406. Similar to the redaction components 204, the unredaction components 206 can comprise a regex unredactor and a NER unredactor having similar respective PII categories and rules.

In operation 408, the merge component 208 merges the non-PII text spans identified in operation 406 with the set of PII candidates from operation 404. In some implementations, the merge component 208 removes PII mentions identified by the redaction components 204 that correspond to a non-PII mention. The correspondence can be direct (e.g., the PII mention matches the non-PII mention) or a text span identified as a PII mention is entirely contained within a text span that is not a PII mention. In other implementations, a machine-trained merge component 208 can determine whether to remove a corresponding PII mention based on a probability that it is a non-PII mention. The result is a final set of PII mentions that should be redacted from the input text.

It is noted that in implementations where the redaction components 204 are not configured to over-redact, operations 406 and 408 are not necessarily and can be optional or removed. For example, the redaction components 204 can be configured or trained to more precisely identify PII mention instead of identifying every possible instance of a PII mention.

In operation 410, the placeholder manager 210 (e.g., the code component 212) generates placeholders or non-PII strings for each unique PII string in the final set of PII mentions. In some implementations, the non-PII string is a unique hashcode comprising a category and a random sequence of text. In some implementations, the non-PII string is a non-original PII string that is of the same type/category (e.g., a non-PII name is generated for a PII name).

In operation 412, the placeholder manager 210 (e.g. the code component 212) replaces each unique PII string with its corresponding placeholder/non-PII string. If the unique PII string occurs more than once in the input text, then every instance of the same unique PII string will be replaced with the same non-PII string. The result of operation 412 is the generation of the redacted text.

In operation 414, the placeholder manager 210 (e.g., the dictionary component 214) generates a mapping dictionary. The mapping dictionary provides a mapping of each unique PII string to the non-PII string that replaces it. The dictionary component 214 stores the mapping dictionary for at least a duration of the downstream processing in a cache or database (e.g., data storage 122). It is noted that operations 410, 412, and/or 414 can be perform substantially simultaneously.

In operation 416, the placeholder manager 210 transmits the redacted text to a downstream system for processing. For example, the redacted text can be transmitted to an external generative AI system that summarizes or generates a response to the redacted text.

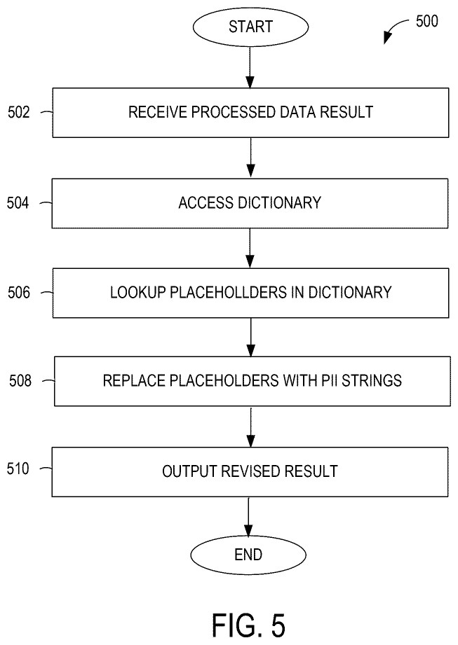

FIG. 5 is a flowchart illustrating operations of a method 500 for reinserting PII information after downstream processing, according to example implementations. Operations in the method 500 may be performed by the placeholder manager 210, using components described above in part with respect to FIG. 2. Accordingly, the method 500 is described by way of example with reference to the placeholder manager 210. However, it shall be appreciated that at least some of the operations of the method 500 may be deployed on various other hardware configurations or be performed by similar components residing elsewhere in the network environment 100 (e.g., at a further system that has a copy of the mapping dictionary). Therefore, the method 500 is not intended to be limited to the placeholder manager 210. It is noted that not all results need to have the original, unique PII strings reinserted. Therefore, the method 500 is only triggered upon receiving a request for reinsertion.

In operation 502, the placeholder manager 210 (e.g., the reinsertion component 216) receives the request for reinsertion along with a result of the processed data from the downstream system. The result will still contain at least some, if not all, of the non-PII strings that replaced the original unique PII strings.

In operation 504, the reinsertion component 216 accesses the mapping dictionary that is associated with the input text and the result. In example implementations, the mapping dictionary can be cached or stored with an identifier that identifies the input text that the mapping dictionary corresponds to. As a result, the reinsertion component 216 can identify and access the mapping dictionary that corresponds to the result.

In operation 506, the reinsertion component 216 looks up placeholders (e.g., the non-PII strings) detected from the result in the mapping dictionary. The corresponding unique PII strings are then retrieved.

In operation 508, the reinsertion component 216 replaces the placeholders with the corresponding unique PII strings. The revised result is then outputted in operation 510. For example, the revised result (e.g., a summarization of the input text) can be stored for future use or transmitted to an agent of the network system 102. In implementations where the processing by the downstream system is occurring substantially in real time, the result can be provided to another system for immediate use. For example, the customer service transcript discussed in FIG. 3A-FIG. 3E can be processed by a downstream system that can provide the customer service agent a response for the customer.

In an alternative implementation, the mapping dictionary is maintained by the dictionary component 214 and a further system sends a request for the matching unique PII strings to the reinsertion component 216. The request can comprise a list of the non-PII strings. The reinsertion component 216 can perform operations 504 and 506 to determine the corresponding unique PII strings. The reinsertion component 216 then generates a response that provides the mapping information (e.g., the unique PII strings) to the further system. The further system can then reinsert the unique PII strings into the result.

FIG. 6 illustrates components of a machine 600, according to some example implementations, that is able to read instructions from a machine-storage medium (e.g., a machine-storage device, a non-transitory machine-storage medium, a computer-storage medium, or any suitable combination thereof) and perform any one or more of the methodologies discussed herein. Specifically, FIG. 6 shows a diagrammatic representation of the machine 600 in the example form of a computer device (e.g., a computer) and within which instructions 624 (e.g., software, a program, an application, an applet, an app, or other executable code) for causing the machine 600 to perform any one or more of the methodologies discussed herein may be executed, in whole or in part.

For example, the instructions 624 may cause the machine 600 to execute the flow diagram of FIG. 6. In one implementation, the instructions 624 can transform the machine 600 into a particular machine (e.g., specially configured machine) programmed to carry out the described and illustrated functions in the manner described.

In alternative implementations, the machine 600 operates as a standalone device or may be connected (e.g., networked) to other machines. In a networked deployment, the machine 600 may operate in the capacity of a server machine or a client machine in a server-client network environment, or as a peer machine in a peer-to-peer (or distributed) network environment. The machine 600 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 624 (sequentially or otherwise) that specify actions to be taken by that machine. Further, while only a single machine is illustrated, the term “machine” shall also be taken to include a collection of machines that individually or jointly execute the instructions 624 to perform any one or more of the methodologies discussed herein.

The machine 600 includes a processor 602 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 604, and a static memory 606, which are configured to communicate with each other via a bus 608. The processor 602 may contain microcircuits that are configurable, temporarily or permanently, by some or all of the instructions 624 such that the processor 602 is configurable to perform any one or more of the methodologies described herein, in whole or in part. For example, a set of one or more microcircuits of the processor 602 may be configurable to execute one or more components described herein.

The machine 600 may further include a graphics display 610 (e.g., a plasma display panel (PDP), a light emitting diode (LED) display, a liquid crystal display (LCD), a projector, or a cathode ray tube (CRT), or any other display capable of displaying graphics or video). The machine 600 may also include an input device 612 (e.g., a keyboard), a cursor control device 614 (e.g., a mouse, a touchpad, a trackball, a joystick, a motion sensor, or other pointing instrument), a storage unit 616, a signal generation device 618 (e.g., a sound card, an amplifier, a speaker, a headphone jack, or any suitable combination thereof), and a network interface device 620.

The storage unit 616 includes a machine-storage medium 622 (e.g., a tangible machine-storage medium) on which is stored the instructions 624 (e.g., software) embodying any one or more of the methodologies or functions described herein. The instructions 624 may also reside, completely or at least partially, within the main memory 604, within the processor 602 (e.g., within the processor's cache memory), or both, before or during execution thereof by the machine 600. Accordingly, the main memory 604 and the processor 602 may be considered as machine-storage media (e.g., tangible and non-transitory machine-storage media). The instructions 624 may be transmitted or received over a network 626 via the network interface device 620.

In some example implementations, the machine 600 may be a portable computing device and have one or more additional input components (e.g., sensors or gauges). Examples of such input components include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the components described herein.

### Executable Instructions and Machine-Storage Medium

The various memories (e.g., 604, 606, and/or memory of the processor(s) 602) and/or storage unit 616 may store one or more sets of instructions and data structures (e.g., software) 624 embodying or utilized by any one or more of the methodologies or functions described herein. These instructions, when executed by processor(s) 602 cause various operations to implement the disclosed implementations.

As used herein, the terms “machine-storage medium,” “device-storage medium,” “computer-storage medium” (referred to collectively as “machine-storage medium 622”) mean the same thing and may be used interchangeably in this disclosure. The terms refer to a single or multiple storage devices and/or media (e.g., a centralized or distributed database, and/or associated caches and servers) that store executable instructions and/or data, as well as cloud-based storage systems or storage networks that include multiple storage apparatus or devices. The terms shall accordingly be taken to include, but not be limited to, solid-state memories, and optical and magnetic media, including memory internal or external to processors. Specific examples of machine-storage media, computer-storage media, and/or device-storage media 622 include non-volatile memory, including by way of example semiconductor memory devices, for example, erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms machine-storage medium or media, computer-storage medium or media, and device-storage medium or media 622 specifically exclude carrier waves, modulated data signals, and other such media, at least some of which are covered under the term “signal medium” discussed below. In this context, the machine-storage medium is non-transitory.

### Signal Medium

The term “signal medium” or “transmission medium” shall be taken to include any form of modulated data signal, carrier wave, and so forth. The term “modulated data signal” means a signal that has one or more of its characteristics set or changed in such a matter as to encode information in the signal.

### Computer Readable Medium

The terms “machine-readable medium,” “computer-readable medium” and “device-readable medium” mean the same thing and may be used interchangeably in this disclosure. The terms are defined to include both machine-storage media and signal media. Thus, the terms include both storage devices/media and carrier waves/modulated data signals.

The instructions 624 may further be transmitted or received over a communications network 626 using a transmission medium via the network interface device 620 and utilizing any one of a number of well-known transfer protocols (e.g., HTTP). Examples of communication networks 626 include a local area network (LAN), a wide area network (WAN), the Internet, mobile telephone networks, plain old telephone service (POTS) networks, and wireless data networks (e.g., Wi-Fi, LTE, and WiMAX networks). The term “transmission medium” shall be taken to include any intangible medium that is capable of storing, encoding, or carrying instructions 624 for execution by the machine 600, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

“Component” refers, for example, to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components.

A “hardware component” is a tangible unit capable of performing certain operations and may be configured or arranged in a certain physical manner. In various example implementations, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein.

In some implementations, a hardware component may be implemented mechanically, electronically, or any suitable combination thereof. For example, a hardware component may include dedicated circuitry or logic that is permanently configured to perform certain operations. For example, a hardware component may be a special-purpose processor, such as a field programmable gate array (FPGA) or an ASIC. A hardware component may also include programmable logic or circuitry that is temporarily configured by software to perform certain operations. For example, a hardware component may include software encompassed within a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where the hardware component comprises a general-purpose processor configured by software to become a special-purpose processor, the general-purpose processor may be configured as respectively different special-purpose processors (e.g., comprising different hardware components) at different times. Software may accordingly configure a processor, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors.

Similarly, the methods described herein may be at least partially processor-implemented, a processor being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example implementations, the one or more processors or processor-implemented components may be located in a single geographic location (e.g., within a home environment, an office environment, or a server farm). In other example implementations, the one or more processors or processor-implemented components may be distributed across a number of geographic locations.

### EXAMPLES

Example 1 is a method for redacting and reinstating personal identifying information (PII) from text data. The method comprises accessing an input text; identifying, by one or more redaction components, personal identifying information (PII) mentions in the input text to be redacted; replacing, by a placeholder manager, each unique PII string of a final set of PII mentions with a non-PII string to generate redacted text, the non-PII string being generated by the placeholder manager; generating and maintaining, by the placeholder manager, a mapping dictionary that maps each unique PII string to the non-PII string that replaces it, the mapping dictionary being used to reinsert one or more unique PII strings after processing of the redacted text; and transmitting the redacted text to a downstream component for the processing.

In example 2, the subject matter of example 1 can optionally include receiving a result of the processing, the result including one or more of the non-PII strings; and using the mapping dictionary, reinserting the one or more unique PII strings that are mapped to the one or more of the non-PII strings in the result.

In example 3, the subject matter of any of examples 1-2 can optionally include transmitting the mapping dictionary to a further system, the further system configured to receive a result of the processing and to reinsert the one or more unique PII strings that are mapped to one or more of the non-PII strings in the result.

In example 4, the subject matter of any of examples 1-3 can optionally include wherein the identifying the PII mentions comprises over-redacting the input text, the method further comprising prior to the replacing, identifying, by one or more unredaction components, one or more text spans that are not PII mentions in the input text; and removing any PII mentions identified by the one or more redaction components that correspond to the one or more text spans to derive the final set of PII mentions.

In example 5, the subject matter of any of examples 1-4 can optionally include wherein the over-redacting comprises identifying any appearance of numbers in the input text; and the identifying the one or more text spans that are not PII mentions comprises identifying non-PII numbers in the input text.

In example 6, the subject matter of any of examples 1-5 can optionally include wherein the removing any PII mentions that correspond to the one or more text spans comprises determining that a text span identified as a PII mention is entirely contained within a text span that is not a PII mention, the text span identified as the PII mention being removed from the final set of PII mentions.

In example 7, the subject matter of any of examples 1-6 can optionally include wherein the removing any PII mentions that correspond to the one or more text spans comprises determining, by a machine-trained merge component, that a PII mention should be removed.

In example 8, the subject matter of any of examples 1-7 can optionally include machine training at least one of the one or more redaction components or at least one of the one or more unredaction components.

In example 9, the subject matter of any of examples 1-8 can optionally include wherein the final set of PII mentions comprises the PII mentions identified by the one or more redaction components.

In example 10, the subject matter of any of examples 1-9 can optionally include wherein the non-PII text comprises a category followed by a unique hash code, the category being identified by the one or more redaction components.

In example 11, the subject matter of any of examples 1-10 can optionally include wherein the one or more redaction components comprises a regular expression (regex) redactor and a named-entity recognition (NER) redactor.

Example 12 is a system for redacting and reinstating personal identifying information (PII) from text data. The system comprises one or more processors and a memory storing instructions that, when executed by the one or more processors, cause the one or more processors to perform operations comprising accessing an input text; identifying, by one or more redaction components, personal identifying information (PII) mentions in the input text to be redacted; replacing, by a placeholder manager, each unique PII string of a final set of PII mentions with a non-PII string to generate redacted text, the non-PII string being generated by the placeholder manager; generating and maintaining, by the placeholder manager, a mapping dictionary that maps each unique PII string to the non-PII string that replaces it, the mapping dictionary being used to reinsert one or more unique PII strings after processing of the redacted text; and transmitting the redacted text to a downstream component for the processing.

In example 13, the subject matter of example 12 can optionally include wherein the operations further comprise receiving a result of the processing, the result including one or more of the non-PII strings; and using the mapping dictionary, reinserting the one or more unique PII strings that are mapped to the one or more of the non-PII strings in the result.

In example 14, the subject matter of any of examples 12-13 can optionally include wherein the operations further comprise transmitting the mapping dictionary to a further system, the further system configured to receive a result of the processing and to reinsert the one or more unique PII strings that are mapped to one or more of the non-PII strings in the result.

In example 15, the subject matter of any of examples 12-14 can optionally include wherein the identifying the PII mentions comprises over-redacting the input text, the operations further comprising prior to the replacing, identifying, by one or more unredaction components, one or more text spans that are not PII mentions in the input text; and removing any PII mentions identified by the one or more redaction components that correspond to the one or more text spans to derive the final set of PII mentions.

In example 16, the subject matter of any of examples 12-15 can optionally include wherein the over-redacting comprises identifying any appearance of numbers in the input text; and the identifying the one or more text spans that are not PII mentions comprises identifying non-PII numbers in the input text.

In example 17, the subject matter of any of examples 12-16 can optionally include wherein the removing any PII mentions that correspond to the one or more text spans comprises determining that a text span identified as a PII mention is entirely contained within a text span that is not a PII mention, the text span identified as the PII mention being removed from the final set of PII mentions.

In example 18, the subject matter of any of examples 12-17 can optionally include wherein the non-PII text comprises a category followed by a unique hash code, the category being identified by the one or more redaction components.

In example 19, the subject matter of any of examples 12-18 can optionally include wherein the one or more redaction components comprises a regular expression (regex) redactor and a named-entity recognition (NER) redactor.

Example 20 is a computer-storage medium comprising instructions which, when executed by one or more processors of a machine, cause the machine to perform operations for redacting and reinstating personal identifying information (PII) from text data. The operations comprise accessing an input text; identifying, by one or more redaction components, personal identifying information (PII) mentions in the input text to be redacted; replacing, by a placeholder manager, each unique PII string of a final set of PII mentions with a non-PII string to generate redacted text, the non-PII string being generated by the placeholder manager; generating and maintaining, by the placeholder manager, a mapping dictionary that maps each unique PII string to the non-PII string that replaces it, the mapping dictionary being used to reinsert one or more unique PII strings after processing of the redacted text; and transmitting the redacted text to a downstream component for the processing.

Some portions of this specification may be presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

Although an overview of the present subject matter has been described with reference to specific examples, various modifications and changes may be made to these examples without departing from the broader scope of examples of the present invention. For instance, various examples or features thereof may be mixed and matched or made optional by a person of ordinary skill in the art. Such examples of the present subject matter may be referred to herein, individually or collectively, by the term “invention” merely for convenience and without intending to voluntarily limit the scope of this application to any single invention or present concept if more than one is, in fact, disclosed.

The examples illustrated herein are believed to be described in sufficient detail to enable those skilled in the art to practice the teachings disclosed. Other examples may be used and derived therefrom, such that structural and logical substitutions and changes may be made without departing from the scope of this disclosure. The Detailed Description, therefore, is not to be taken in a limiting sense, and the scope of various examples is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various examples of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of examples of the present invention as represented by the appended claims. The specification and drawings are, accordingly, to be regarded in an illustrative rather than a restrictive sense.

What is claimed is:

1. A method comprising:
accessing an input text;
identifying, by one or more redaction components, personal identifying information (PII) mentions in the input text to be redacted;
replacing, by a placeholder manager, each unique PII string of a final set of PII mentions with a non-PII string to generate redacted text, the non-PII string being generated by the placeholder manager;
generating and maintaining, by the placeholder manager, a mapping dictionary that maps each unique PII string to the non-PII string that replaces it, the mapping dictionary being used to reinsert one or more unique PII strings after processing of the redacted text; and
transmitting the redacted text to a downstream component for the processing.

2. The method of claim 1, further comprising:
receiving a result of the processing, the result including one or more of the non-PII strings; and
using the mapping dictionary, reinserting the one or more unique PII strings that are mapped to the one or more of the non-PII strings in the result.

3. The method of claim 1, further comprising:
transmitting the mapping dictionary to a further system, the further system configured to receive a result of the processing and to reinsert the one or more unique PII strings that are mapped to one or more of the non-PII strings in the result.

4. The method of claim 1, wherein the identifying the PII mentions comprises over-redacting the input text, the method further comprising:
prior to the replacing, identifying, by one or more unredaction components, one or more text spans that are not PII mentions in the input text; and
removing any PII mentions identified by the one or more redaction components that correspond to the one or more text spans to derive the final set of PII mentions.

5. The method of claim 4, wherein:
the over-redacting comprises identifying any appearance of numbers in the input text; and
the identifying the one or more text spans that are not PII mentions comprises identifying non-PII numbers in the input text.

6. The method of claim 4, wherein the removing any PII mentions that correspond to the one or more text spans comprises determining that a text span identified as a PII mention is entirely contained within a text span that is not a PII mention, the text span identified as the PII mention being removed from the final set of PII mentions.

7. The method of claim 4, wherein the removing any PII mentions that correspond to the one or more text spans comprises determining, by a machine-trained merge component, that a PII mention should be removed.

8. The method of claim 4, further comprising:
machine training at least one of the one or more redaction components or at least one of the one or more unredaction components.

9. The method of claim 1, wherein the final set of PII mentions comprises the PII mentions identified by the one or more redaction components.

10. The method of claim 1, wherein the non-PII text comprises a category followed by a unique hash code, the category being identified by the one or more redaction components.

11. The method of claim 1, wherein the one or more redaction components comprises a regular expression (regex) redactor and a named-entity recognition (NER) redactor.

12. A system comprising:
one or more processors; and
a memory storing instructions that, when executed by the one or more processors, cause the one or more processors to perform operations comprising:
accessing an input text;
identifying, by one or more redaction components, personal identifying information (PII) mentions in the input text to be redacted;
replacing, by a placeholder manager, each unique PII string of a final set of PII mentions with a non-PII string to generate redacted text, the non-PII string being generated by the placeholder manager;
generating and maintaining, by the placeholder manager, a mapping dictionary that maps each unique PII string to the non-PII string that replaces it, the mapping dictionary being used to reinsert one or more unique PII strings after processing of the redacted text; and
transmitting the redacted text to a downstream component for the processing.

13. The system of claim 12, wherein the operations further comprise:
receiving a result of the processing, the result including one or more of the non-PII strings; and
using the mapping dictionary, reinserting the one or more unique PII strings that are mapped to the one or more of the non-PII strings in the result.

14. The system of claim 12, wherein the operations further comprise:
transmitting the mapping dictionary to a further system, the further system configured to receive a result of the processing and to reinsert the one or more unique PII strings that are mapped to one or more of the non-PII strings in the result.

15. The system of claim 12, wherein the identifying the PII mentions comprises over-redacting the input text, the operations further comprising:
prior to the replacing, identifying, by one or more unredaction components, one or more text spans that are not PII mentions in the input text; and
removing any PII mentions identified by the one or more redaction components that correspond to the one or more text spans to derive the final set of PII mentions.

16. The system of claim 15, wherein:
the over-redacting comprises identifying any appearance of numbers in the input text; and
the identifying the one or more text spans that are not PII mentions comprises identifying non-PII numbers in the input text.

17. The system of claim 15, wherein the removing any PII mentions that correspond to the one or more text spans comprises determining that a text span identified as a PII mention is entirely contained within a text span that is not a PII mention, the text span identified as the PII mention being removed from the final set of PII mentions.

18. The system of claim 12, wherein the non-PII text comprises a category followed by a unique hash code, the category being identified by the one or more redaction components.

19. The system of claim 12, wherein the one or more redaction components comprises a regular expression (regex) redactor and a named-entity recognition (NER) redactor.

20. A machine-storage medium comprising instructions which, when executed by one or more processors of a machine, cause the machine to perform operations comprising:
accessing an input text;
identifying, by one or more redaction components, personal identifying information (PII) mentions in the input text to be redacted;
replacing, by a placeholder manager, each unique PII string of a final set of PII mentions with a non-PII string to generate redacted text, the non-PII string being generated by the placeholder manager;
generating and maintaining, by the placeholder manager, a mapping dictionary that maps each unique PII string to the non-PII string that replaces it, the mapping dictionary being used to reinsert one or more unique PII strings after processing of the redacted text; and
transmitting the redacted text to a downstream component for the processing.
